(19) United States
(12) Patent Application Publication
(10) Pub. No.: US 2012/0251769 A1
(43) Pub. Date: Oct. 4, 2012

(54) LIQUID CRYSTALLINE POLYMER MOLDED ARTICLE

(75) Inventors: Hiroshi HARADA, Tsukuba-shi (JP); Satoshi SEKIMURA, Tsukuba-shi (JP)

(73) Assignee: SUMITOMO CHEMICAL COMPANY, LIMITED, Tokyo (JP)

(21) Appl. No.: 13/425,573

(22) Filed: Mar. 21, 2012

(30) Foreign Application Priority Data
Mar. 30, 2011 (JP) 2011-074857

(51) Int. Cl. B32B 3/24

(52) U.S. Cl. 428/131

(57) ABSTRACT

Provided is a liquid crystal polymer molding including an opening portion in which a weld portion has high strength and also surface properties are satisfactory. A liquid crystal polymer molding including an opening portion obtained by subjecting a liquid crystal polymer composition containing a spherical filler to injection molding, wherein the liquid crystal polymer molding includes a weld portion, formed by injection molding, which extends toward the outside from the opening portion, and the weld portion has a thickness in the opening portion of 2.5 mm or less, and also has a length, along a surface of the molding, of at least two times the thickness.

### BACKGROUND OF THE INVENTION

1. Field of the Invention

The present invention relates to a liquid crystalline polymer molded article.

2. Description of the Related Art

A liquid Crystalline polymer, particularly a liquid crystalline polymer having melt crystallinity has such features that it includes a rigid molecular frame and exhibits mesomorphism at the time of melting, and molecular chain orientation at the time of shear flow and extension flow. Because of such features, the liquid crystalline polymer exhibits excellent fluidity in case of subjecting to melt processing such as injection molding, extrusion molding, inflation molding or blow molding, and gives a molded article with excellent in mechanical properties. Particularly, an aromatic liquid crystalline polymer gives a molding which has, in addition to excellent fluidity at the time of molding, chemical stability and also high heat resistance, high strength and high rigidity which originate in a rigid molecular frame, and is therefore useful as an engineering plastic to which “light-weighting”, “thinning” and “downsizing” are required. It is particularly useful as electric and electronic components each including a thin wall portion which are subjected to a surface mounting step, and electric and electronic components each having high output and high capacity which are exposed to a high temperature when used, automotive members and the like.

However, the liquid crystalline polymer has a problem that a weld portion has remarkably low strength because of very large anisotropy and high solidification rate. Herein, the weld portion means a portion where two or more liquid crystalline polymer melts flowing in a mold junction are welded as a result of junction in case of injection molding. Thus, there is disclosed a method for producing a molding using a composition in which a liquid crystalline polymer is mixed with a filler such as a glass fiber so as to reduce anisotropy and to increase the strength of the weld portion. However, this production method has a problem that large effect of improving the strength of the weld portion is not necessarily exerted, and also the surface of the molding is roughened, resulting in deterioration of surface properties.

To the contrary, JP-A-3-59067 discloses an optically anisotropic polyester resin composition, that is, a liquid crystalline polymer composition composed of a specific ratio of an optically anisotropic polyester having a specific structure, a liquid crystal transition temperature and a melt viscosity as a liquid crystalline polymer having excellent heat resistance, moldability and fluidity and also having high mechanical properties, particularly high strength of a weld portion of a molding, and a specific ratio of a needle-shaped titanium oxide whisker and/or a needle-shaped aluminum borate whisker.

JP-A-3-281656 discloses that a liquid crystal polyester resin composition composed of a specific ratio of a liquid crystalline polyester and a specific ratio of an aluminum borate whisker reduces the anisotropy of the liquid crystalline polyester to improve the strength of a weld portion of a molding.

However, the compositions described in JP-A-3-59067 and JP-A-3-281656 have a problem that when a molding including an opening portion is produced by injection molding, cracking occurs in a weld portion extending toward the outside from the opening portion of the molded article in a cooling process after molding. Particularly, when the thickness is 3 mm or more, the strength of the weld portion increases. However, when the thickness is 2.5 mm or less, the strength decreases and cracking is likely to occur in the cooling process of the molding. There is also a problem that surface properties deteriorate, for example, roughening and a flow mark distinctly occur on a surface of the molding.

### SUMMARY OF THE INVENTION

Under the above-mentioned circumstances, the present invention has been made, and an object thereof is to provide a liquid crystalline polymer molded article including an opening portion in which a weld portion has high strength and also surface properties are satisfactory.

In order to achieve the above object, the present invention provides a liquid crystalline polymer molding comprising an opening portion obtained by subjecting a liquid crystalline polymer composition containing a spherical filler to injection molding, wherein the liquid crystalline polymer molding includes a weld portion, formed by injection molding, which extends toward the outside from the opening portion, and the weld portion has a thickness in the opening portion of 2.5 mm or less, and also has a length, along a surface of the molding, of at least two times the thickness.

In the liquid crystalline polymer molded article of the present invention, the liquid crystalline polymer is preferably a liquid crystalline polyester.

In the liquid crystalline polymer molding of the present invention, the liquid crystalline polyester preferably includes a repeating unit derived from p-hydroxybenzoic acid in the proportion of 30 mol % or more based on the total amount of the whole repeating unit which constitutes the liquid crystalline polyester.

The liquid crystalline polymer molded article of the present invention is preferably obtained by injection molding under the conditions that injection acceleration defined by dividing the maximum value of an injection rate by time required to reach the maximum value from initiation of the injection is from 1,000 to 25,000 mm/sec², and also the maximum value of injection pressure in a mold inlet is from 5 to 150 MPa in one injection molding.

The liquid crystalline polymer molding of the present invention is preferably obtained by injection molding under the conditions that the temperature of the liquid crystalline polymer composition at the time of injection is [flow initiation temperature of the liquid crystalline polymer composition+20° C.] or higher and [flow temperature of the liquid crystalline polymer composition+80° C.] or lower.

The liquid crystalline polymer molded article of the present invention is preferably obtained by injection molding under the conditions that the temperature of a mold at the time of injection molding is 80° C. or higher and [flow initiation temperature of the liquid crystalline polymer composition−100° C.] or lower.

The liquid crystalline polymer molded article of the present invention is preferably a component for a compact camera module.

According to the present invention, it is possible to provide a liquid crystalline polymer molded article including an opening portion in which a weld portion has high strength and also surface properties are satisfactory.

### BRIEF DESCRIPTION OF THE DRAWINGS

FIG. 1 is a perspective view illustrating a molded article according to one embodiment of the present invention.

### DETAILED DESCRIPTION OF THE INVENTION

The present invention will be described in detail below.

The liquid crystalline polymer molded article molding of the present invention (hereinafter sometimes simply referred to as a molding) is a liquid crystalline polymer molded article including an opening portion obtained by subjecting a liquid crystalline polymer composition containing a spherical filler to injection molding, wherein the liquid crystalline polymer molded article includes a weld portion, formed by injection molding, which extends toward the outside from the opening portion, and the weld portion has a thickness in the opening portion of 2.5 mm or less, and also has a length, along a surface of the molding, of at least two times the thickness.

The opening portion of the molding is formed by injecting a melt of the liquid crystalline polymer composition into a mold from one (upstream side) toward the other (downstream side) using a mold provided with a structure for forming the opening portion inside. The liquid crystalline polymer composition thus injected into the mold hits against the structure thereby being divided into two fluids, which flow in the mold. After passing the structure, these two fluids join and thus the liquid crystalline polymer composition surrounds the structure. Thus, the molded article removed from the mold has an opening portion at the site where the structure was present. At this time, the site at which two fluids join in the mold are integrated by welding to form a weld portion in the molding. Accordingly, the weld portion extends from the site of the downstream side of the opening portion toward the downmost stream side (i.e., outside).

The weld portion is not necessarily confirmed visually from the surface side in the molded article. However, in the molded article of the present invention, the presence of the weld portion can be confirmed by observing the dispersion state or arrangement state of a spherical filler in the cross section thereof using a microscope or the like, or by analyzing the orientation of a liquid crystalline polymer.

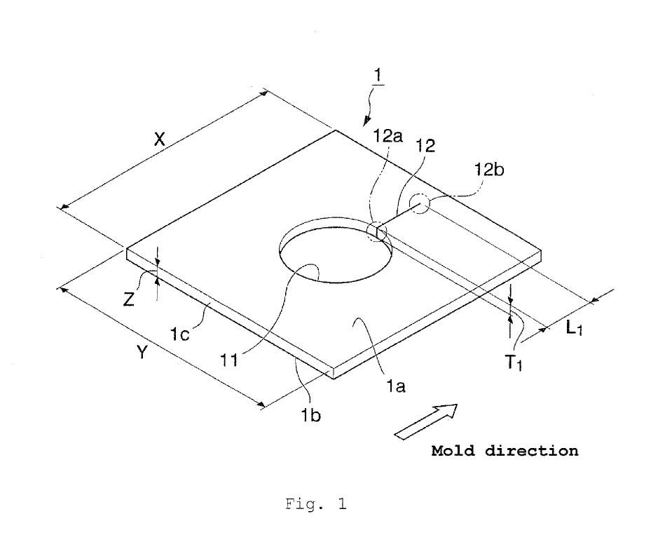

FIG. 1 is a perspective view illustrating a molded article according to one embodiment of the present invention.

A molded article 1 shown in the FIGURE has a shape of a thin plate, and an opening surface includes a circular opening portion 11. A surface 1a and a rear surface 1b provided with the opening portion have a square external form, and the opening portion 11 is provided concentrically with the molded article 1.

A melt of a liquid crystalline polymer composition is injected into a mold (not shown) in a direction indicated by arrow in FIG. 1, and a fluid of the liquid crystalline polymer composition flows in the mold from the upstream side toward the downstream side and filled and molded, and thus the molded article 1 is obtained.

A weld portion 12 extends from a part (site of the downstream side in the flow direction of the liquid crystalline polymer composition) of the opening portion 11 toward the outside (i.e., the downmost stream side in the flow direction of the liquid crystalline polymer composition) of the molded article 1. One end 12a of the weld portion 12 overlaps with the opening portion 11.

Lengths X and Y of the side of the external form of the surface 1a and rear surface 1b provided with the opening portion of the molded article 1, as well as a thickness Z other than the opening portion 11 of the molded article 1 can be optionally set. Herein, Z represents a thickness in an outer peripheral portion 1c. Herein, Z is a given value in the molded article 1 and may be a value which varies depending on the site.

A thickness T₁ in the opening portion 11 (one end 12a) of the weld portion 12 is 2.5 mm or less. Even in such a range, the weld portion 12 has high strength, and thus cracking is suppressed. Furthermore, T₁ is preferably 1 mm or less, more preferably 0.5 mm or less, and still more preferably 0.2 mm or less, from the viewpoint of the remarkable cracking suppressing effect of the weld portion 12. There is no particular limitation on the lower limit value of T₁ as long as it is not 0 (zero), and the lower limit value is preferably 0.02 mm. It is possible to easily inject the melt of the liquid crystalline polymer composition into the mold at the time of molding by adjusting the lower limit value within the above range.

Herein, T₁ and Z may be the same, but may be different from each other.

Furthermore, the length L₁ along with the surface 1a (or rear surface 1b) between one end 12a of the weld portion 12, and the other end 12b at the opposite side is at least 2 times the thickness T₁ (L₁≧2T₁). Consequently, the cracking suppressing effect of the weld portion 12 is improved. From the viewpoint of improving such an effect, L₁ is preferably at least three times the thickness T₁.

The molded article 1 is merely illustrated as an example of the liquid crystalline polymer molded article of the present invention and the liquid crystalline polymer molded article of the present invention is not limited thereto as long as it includes the weld portion. For example, the external form of the molded article and the shape of the opening surface may be other than quadrangle. The opening portion may not be provided concentrically with the molded article. The other end of the weld portion may also be overlapped with the outer peripheral portion of the molded article. The number of the opening portion and weld portion may be other than one.

In the present invention, there is no particular limitation on the liquid crystalline polymer, and the liquid crystalline polymer is preferably a liquid crystalline polyester.

The liquid crystalline polyester is a liquid crystalline polyester which exhibits mesomorphism in a melted state, and is preferably melted at a temperature of 450° C. or lower. The liquid crystalline polyester may also be a liquid crystalline polyester amide, a liquid crystalline polyester ether, a liquid crystalline polyester carbonate, or a liquid crystalline polyester imide. The liquid crystalline polyester is preferably a whole aromatic liquid crystalline polyester in which only an aromatic compound is used as a raw material monomer.

Typical examples of the liquid crystalline polyester include:
(I) those obtained by polymerizing (polycondensing) an aromatic hydroxycarboxylic acid, an aromatic dicarboxylic acid, and at least one kind of a compound selected from the group consisting of an aromatic diol, an aromatic hydroxylamine and an aromatic diamine;
(II) those obtained by polymerizing plural kinds of aromatic hydroxycarboxylic acids,
(III) those obtained by polymerizing an aromatic dicarboxylic acid with at least one kind of a compound selected from the group consisting of an aromatic diol, an aromatic hydroxylamine and an aromatic diamine,
(IV) those obtained by polymerizing a polyester such as polyethylene terephthalate with an aromatic hydroxycarboxylic acid. Herein, a polymerizable derivative of an aromatic hydroxycarboxylic acid, an aromatic dicarboxylic acid, an aromatic diol, an aromatic hydroxylamine and an aromatic diamine may be used, respectively independently, in place of a part or all thereof.

Examples of the polymerizable derivative of a compound having a carboxyl group, such as an aromatic hydroxycarboxylic acid and an aromatic dicarboxylic acid, include those in which a carboxyl group is converted into an alkoxycarbonyl group or an aryloxycarbonyl group (ester), those in which a carboxyl group is converted into a haloformyl group (acid halide), and those in which a carboxyl group is converted into an acyloxycarbonyl group (acid anhydride).

Examples of the polymerizable derivative of a compound having a hydroxyl group, such as an aromatic hydroxycarboxylic acid, an aromatic diol and an aromatic hydroxylamine, include those in which a hydroxyl group is converted into an acyloxyl group by acylation (acylate).

Examples of the polymerizable derivative of a compound having an amino group, such as an aromatic hydroxylamine and an aromatic diamine, include those in which an amino group is converted into an acylamino group by acylation (acylate).

The liquid crystalline polyester preferably includes a repeating unit represented by the following general formula (1) (hereinafter sometimes referred to as a “repeating unit (1)”), and more preferably includes a repeating unit (1), a repeating unit represented by the following general formula (2) (hereinafter sometimes referred to as a “repeating unit (2)”), and a repeating unit represented by the following general formula (3) (hereinafter sometimes referred to as a “repeating unit (3)”)

—O—Ar¹—CO—, (1)

—CO—Ar²—CO—, (2)

and

—X—Ar³—Y— (3)

wherein Ar¹ represents a phenylene group, a naphthylene group or a biphenylene group; Ar² and Ar³ each independently represents a phenylene group, a naphthylene group, a biphenylene group, or a group represented by the following general formula (4); X and Y each independently represents an oxygen atom or an imino group; and one or more hydrogen atoms in Ar¹, Ar² and Ar³ each independently may be substituted with a halogen atom, an alkyl group or an aryl group,

—Ar⁴—Z—Ar⁵ (4)

wherein Ar⁴ and Ar⁵ each independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom.

Examples of the alkyl group include a methyl group, an ethyl group, a n-propyl group, an isopropyl group, a n-butyl group, an isobutyl group, a sec-butyl group, a tert-butyl group, a n-butyl group, a n-hexyl group, a n-heptyl group, a 2-ethylhexyl group, a n-octyl group, a n-nonyl group and a n-decyl group, and the number of carbon atoms is preferably from 1 to 10.

Examples of the aryl group include a phenyl group, an o-tolyl group, a m-tolyl group, a p-tolyl group, a 1-naphthyl group and a 2-naphthyl group, and the number of carbon atoms is preferably from 6 to 20.

When the hydrogen atom is substituted with these groups, the number thereof is preferably 2 or less, and more preferably 1 or less, every group represented by Ar¹, Ar² or Ar³, respectively, independently.

Examples of the alkylidene group include a methylene group, an ethylidene group, an isopropylidene group, a n-butylidene group and a 2-ethylhexylidene group, and the number of carbon atoms is preferably from 1 to 10.

The repeating unit (1) is a repeating unit derived from a predetermined aromatic hydroxycarboxylic acid. The repeating unit (1) is preferably a repeating unit in which Ar¹ is a p-phenylene group (a repeating unit derived from p-hydroxybenzoic acid), or a repeating unit in which Ar¹ is a 2,6-naphthylene group (a repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar³ is a p-phenylene group (a repeating unit derived from terephthalic acid), a repeating unit in which Ar² is a m-phenylene group (a repeating unit derived from isophthalic acid), a repeating unit in which Ar² is a 2,6-naphthylene group (a repeating unit derived from 2,6-naphthalenedicarboxylic acid), or a repeating unit in which Ar² is a diphenylether-4,4′-diyl group (a repeating unit derived from diphenylether-4,4′-dicarboxylic acid).

The repeating unit (3) is a repeating unit derived from a predetermined aromatic diol, aromatic hydroxylamine or aromatic diamine. The repeating unit (3) is preferably a repeating unit in which Ar³ is a p-phenylene group (a repeating unit derived from hydroquinone, p-aminophenol or p-phenylenediamine), or a repeating unit in which Ar^{a} is a 4,4′-biphenylene group (a repeating unit derived from 4,4′-dihydroxybiphenyl, 4-amino-4′-hydroxybiphenyl or 4,4′-diaminobiphenyl).

The content of the repeating unit (1) is preferably 30 mol % or more, more preferably 30 to 80 mol %, still more preferably 40 to 70 mol %, and particularly preferably 45 to 65 mol %, based on the total amount of the whole repeating unit constituting the liquid crystal polyester (value in which the mass of each repeating unit constituting a liquid crystal polyester is divided by the formula weight of each repeating unit to obtain an amount (mol) equivalent to the amount of a substance of each repeating unit, and then masses thus obtained are totalized).

The content of the repeating unit (2) is preferably 35 mol % or less, more preferably from 10 to 35 mol %, still more preferably from 15 to 30 mol %, and particularly preferably from 17.5 to 27.5 mol %, based on the total amount of the whole repeating unit constituting the liquid crystal polyester.

The content of the repeating unit (3) is preferably 35 mol % or less, more preferably from 10 to 35 mol %, still more preferably from 15 to 30 mol %, and particularly preferably from 17.5 to 27.5 mol %, based on the total amount of the whole repeating unit constituting the liquid crystal polyester.

As the content of the repeating unit (1) increases, melt fluidity, heat resistance, strength and rigidity are likely to be improved. However, when the content is too large, melting temperature and melt viscosity are likely to increase and the temperature required to molding is likely to increase.

The liquid crystal polyester preferably includes a repeating unit derived from p-hydroxybenzoic acid in the proportion of 30 mol % or more based on the total amount of the whole repeating unit constituting the liquid crystal polyester.

The ratio of the content of the repeating unit (2) to the content of the repeating unit (3) is preferably from 0.9/1 to 1/0.9, more preferably from 0.95/1 to 1/0.95, and still more preferably from 0.98/1 to 1/0.98, in terms of [content of the repeating unit (2)]/[content of the repeating unit (3)] (mol/mol).

The liquid crystalline polyester may include two or more kinds of the repeating units (1) to (3), respectively, independently. The liquid crystalline polyester may include repeating units other than the repeating units (1) to (3), and the content thereof is preferably 10 mol % or less, and more preferably 5 mol % or less, based on the total amount of the whole repeating unit constituting the liquid crystalline polyester.

The liquid crystalline polyester preferably includes, as the repeating unit (3), those in which X and Y are respectively oxygen atoms, that is, a repeating unit derived from a predetermined aromatic diol, and more preferably includes, as the repeating unit (3), only those in which X and Y are respectively oxygen atoms. Consequently, the melt viscosity of the liquid crystalline polyester is likely to decrease.

The liquid crystalline polyester is preferably produced by melt-polymerizing a raw material monomer corresponding to a repeating unit constituting the liquid crystalline polyester, and then subjecting the obtained polymer (prepolymer) to solid phase polymerization. This makes it possible to produce a high molecular weight liquid crystalline polyester having heat resistance as well as high strength and rigidity with satisfactory operability. The melt polymerization may be performed in the presence of a catalyst. In this case, examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among these catalysts, nitrogen-containing heterocyclic compounds are preferably used.

The flow initiation temperature of the liquid crystal polyester is preferably 270° C. or higher, more preferably from 270° C. to 400° C., and still more preferably from 280° C. to 380° C. As the flow initiation temperature increases, heat resistance as well as strength and rigidity are likely to be improved. When the flow initiation temperature is too high, the melting temperature and the melt viscosity are likely to increases and the temperature required to molding is likely to increase.

The flow initiation temperature is also referred to as a flow temperature and means a temperature at which the melt viscosity becomes 4,800 Pa·s (48,000 poise) when a liquid crystalline polyester is melted while heating at a heating rate of 4° C./minute under a load of 9.8 MPa (100 kg/cm²) and extruded through a nozzle having an inner diameter of 1 mm and a length of 10 mm using a capillary rheometer, and the flow initiation temperature serves as an index indicating the molecular weight of the liquid crystalline polyester (see “Liquid Crystalline Polymer-Synthesis, Molding, and Application” edited by Naoyuki Koide, page 95, published by CMC on Jun. 5, 1987).

When other liquid crystalline polymers, or liquid crystalline polymer compositions are used in place of the liquid crystalline polyester, these flow initiation temperatures can be measured in the same manner as described above.

The spherical filler to be used in the preparation of the liquid crystalline polymer composition is a particle-shaped filler which does not extend in a specific direction, such as a fiber-shaped filler, a plate-shaped filler and a strip-shaped filler, and the average sphericity thereof is preferably 3 or less, more preferably from 1 to 2, still more preferably from 1 to 1.5, and particularly preferably from 1 to 1.2. As used herein, the average sphericity means an average of sphericities, which is obtained by selecting 30 fillers at random from a lot of fillers, observing the fillers, measuring a maximum length D1 and minimum length D2 of each filler, and then determining a value of D1/D2 as the sphericity. Observation can be performed, for example, by projecting using a profile projector, or using a high magnification stereo microscope.

The average particle diameter of the spherical filler is preferably from 0.01 to 1,000 μm, more preferably from 0.1 to 500 μm, still more preferably from 1 to 100 μm, and particularly preferably from 10 to 75 μm.

Specific examples of the spherical filler include those made of glasses such as glass beads, glass powder and hollow glass; and those made of materials, for example, kaolin, clay, vermiculite; silicates such as calcium silicate, aluminum silicate, a feldspar powder, acid clay, pyrophyllite clay, sericite, sillimanite, bentonite, a slate powder and silane; carbonates such as calcium carbonate, whitewash, barium carbonate, magnesium carbonate and dolomite; sulfates such as a baryta powder, blanc fixe, precipitated calcium sulfate, calcined gypsum and barium sulfate; hydroxides such as hydrated alumina; oxides such as alumina, antimony oxide, magnesia, titanium oxide, zinc oxide, silica, quartz sand, quartz, white carbon and diatomaceous earth; sulfides such as molybdenum disulfide; metal particulate matters; organic polymers such as a fluorine resin; and organic low molecular weight crystals such as brominated diphenylether; and also include particulate matters having a small aspect ratio. These spherical fillers may be used alone, or two or more kinds may be used in combination. Among these fillers, glass beads and hollow glass are typical spherical fillers.

There is no particular limitation on the content of the spherical filler of the liquid crystalline polymer composition. In order to maintain the fluidity of the liquid crystalline polymer composition and to improve surface properties without causing deterioration of characteristics such as the strength and dimensional stability of the molded article to thereby enhance the cracking suppressing effect of the weld portion, the content of the spherical filler is preferably from 1 to 70% by mass. When the content is adjusted to the lower limit value or more, the surface properties are more improved and thus the cracking suppressing effect of the weld portion is more enhanced. Further, when the content is adjusted to the upper limit value or less, the fluidity of the resin is improved and moldability becomes more satisfactory, and thus the mechanical properties of the molded article are improved. From the viewpoint of effectively improving the surface properties while maintaining satisfactory moldability to thereby effectively suppress cracking of the weld portion, the content of the spherical filler is more preferably from 20 to 60% by mass, and still more preferably from 25 to 50% by mass.

Taking the shape of the spherical filler into consideration, it is estimated that the spherical filler exerts less effect of improving the strength of the weld portion in the molded article as compared with other fillers such as a fiber-shaped filler, a plate-shaped filler and a strip-shaped filler. However, surprisingly, the spherical filler exerts the highest effect of improving the strength in the present invention.

The liquid crystalline polymer composition may contain one or more other components such as fillers other than the spherical filler, additives and resins other than the liquid crystal polymer as long as the object of the present invention is not impaired.

Fillers other than the spherical filler may be fiber-shaped fillers, plate-shaped fillers, or particle-shaped filler other than fiber-shaped and plate-shaped fillers. The fillers may be inorganic fillers, or organic fillers.

Examples of the fiber-shaped inorganic filler include glass fibers; carbon fibers such as a PAN-based carbon fiber and a pitch-based carbon fiber; ceramic fibers such as a silica fiber, an alumina fiber and a silica alumina fiber; and metal fibers such as a stainless steel fiber. Examples thereof also include whiskers such as a potassium titanate whisker, a barium titanate whisker, a wollastonite whisker, an aluminum borate whisker, a silicon nitride whisker and a silicon carbide whisker.

Examples of the fiber-shaped organic filler include a polyester fiber and an aramide fiber.

Examples of the plate-shaped inorganic filler include talc, mica, graphite, wollastonite, glass flake, barium sulfate and calcium carbonate. Mica may be muscovite, phlogopite, fluorphlogopite or tetrasilicic mica.

Examples of the particle-shaped inorganic filler include silica, alumina, titanium oxide, boron nitride, silicon carbide and calcium carbonate.

The content of the filler is preferably from 0 to 100 parts by mass based on 100 parts by mass of the liquid crystalline polymer.

Examples of the additive include an antioxidant, a heat stabilizer, an ultraviolet absorber, an antistatic agent, a surfactant, a flame retardant, a lubricant, a releasant and a colorant.

The content of the additive is preferably from 0 to 5 parts by mass based on 100 parts by mass of the liquid crystalline polymer.

Examples of the resin other than the liquid crystalline polymer include thermoplastic resins such as polypropylene, polyamide, polyester, polysulfone, polyphenylene sulfide, polyetherketone, polycarbonate, polyphenylene ether and polyetherimide; and thermosetting resins which do not correspond to the liquid crystalline polymer, such as a phenol resin, an epoxy resin, a polyimide resin and a cyanate resin.

The content of the resin other than the liquid crystalline polymer is preferably from 0 to 20 parts by mass based on 100 parts by mass of the liquid crystalline polymer.

The liquid crystalline polymer composition is preferably prepared by melt-kneading the liquid crystalline polymer, the spherical filler and optionally usable other components using an extruder, and then extruding the melt-kneaded mixture into pellets. As the extruder, an extruder including a cylinder, one or more screws disposed in the cylinder, and one or more supply ports provided in the cylinder is preferably used, and an extruder further including one or more vent portions provided in the cylinder is more preferably used.

In case of subjecting the liquid crystalline polymer composition to injection molding, molding may be performed using a selected mold having a desired shape in which the thickness in the opening portion of the weld portion is adjusted so as to become a predetermined value.

In case of subjecting the liquid crystalline polymer composition to injection molding, injection acceleration defined by dividing the maximum value of an injection rate Vₘₐₓ by time required to reach the maximum value from initiation of the injection t₁ (Vₘₐₓ/t₁) is preferably adjusted within a range from 500 to 25,000 mm/sec², and more preferably from 1,000 to 25,000 mm/sec², in one injection molding. The injection rate may be observed, for example, by a waveform monitor.

The cracking suppressing effect of the weld portion is more improved by adjusting the injection acceleration to the lower limit value or more. By adjusting to the upper limit value or less, a special machine as an injection molding machine becomes unnecessary and thus the versatility is improved.

In case of subjecting the liquid crystalline polymer composition to injection molding, the maximum value of injection pressure in a mold inlet is preferably adjusted within a range from 5 to 150 MPa in one injection molding. The injection pressure may be read, for example, from the pressure waveform.

The cracking suppressing effect of the weld portion is more improved by adjusting the injection pressure to the lower limit value or more. By adjusting to the upper limit value or less, the occurrence of burr in the molding is suppressed, and also removal of the molded article from the mold is facilitated. Therefore, cracking of the weld portion associated with deformation of the molded article at the time of mold removal is suppressed.

In the present invention, when the liquid crystalline polymer composition is subjected to injection molding, both the injection acceleration and the injection pressure are preferably adjusted to the numerical values within the above range.

When the liquid crystalline polymer composition is subjected to injection molding, it is preferred that the flow initiation temperature of the liquid crystalline polymer composition is determined by the below-mentioned method, first, and then the temperature (actual temperature of the liquid crystalline polymer composition in a melted state) of the liquid crystalline polymer composition at the time of injection is adjusted to [flow initiation temperature of the liquid crystalline polymer composition+20° C.] or higher and [flow initiation temperature of the liquid crystalline polymer composition+80° C.] or lower.

By adjusting the temperature to the lower limit value or more, roughening of a surface of the obtained molded article is suppressed and thus surface properties are more improved. Furthermore, the cracking suppressing effect of the weld portion is more improved. By adjusting to the upper limit value or less, decomposition of the liquid crystalline polymer retained in the molding machine is suppressed and thus the surface properties of the molded article are more improved. Furthermore, outflow of the melted resin through a nozzle is suppressed at the time of removal of the molded article from the mold after molding is suppressed and thus productivity of the molding is more improved.

From the viewpoint of more improving the cracking suppressing effect of the weld portion and moldability, the temperature of the liquid crystalline polymer composition at the time of injection is preferably adjusted to [flow initiation temperature of the liquid crystal polymer composition+30° C.] or higher and [flow initiation temperature of the liquid crystal polymer composition+60° C.] or lower.

When the liquid crystalline polymer composition is subjected to injection molding, the temperature of the mold is preferably adjusted to 80° C. or higher. Consequently, roughening of a surface of the obtained molded article is suppressed and thus surface properties are more improved. Furthermore, the cracking suppressing effect of the weld portion is more improved.

When the liquid crystalline polymer composition is subjected to injection molding, the upper limit value of the temperature of the mold is preferably adjusted appropriately according to the kind of the liquid crystalline polymer composition so as to prevent decomposition of the liquid crystalline polymer composition, and more preferably adjusted to [flow initiation temperature of the liquid crystal polymer composition−50° C.]. Consequently, the cooling time of the molded article after molding can be shortened and thus productivity is improved. Furthermore, removal of the molded article from the mold is facilitated and thus deformation of the molding is suppressed. Furthermore, since mutual engagement of molds is improved, breakage of the mold at the time of opening portion and closing of the mold is suppressed.

Since the above-mentioned effect is exerted more remarkably, the temperature of the mold is preferably adjusted to 80° C. or higher and [flow initiation temperature of the liquid crystalline polymer composition−100° C.] or lower, more preferably 100° C. or higher and [flow initiation temperature of the liquid crystalline polymer composition−100° C.] or lower, and still more preferably 130° C. or higher and [flow initiation temperature of the liquid crystalline polymer composition−100° C.] or lower.

A method for determining more practical injection molding conditions will be described below. In the present method, a flat plate-shaped molding including an opening portion having a diameter of 3 mm, and having a given thickness of 2 mm is regarded as a standard molding. The standard molding is produced by injection-molding while varying molding conditions, and the injection molding conditions are optimized by performing a bending strength test of the weld portion thereof. To take an instance, first, the temperature of a liquid crystalline polymer composition at the time of injection is adjusted to a suitable range (for example, [flow initiation temperature of a liquid crystalline polymer composition+20° C.] or higher and [flow initiation temperature of a liquid crystalline polymer composition+80° C.] or lower), injection acceleration is adjusted to a suitable range (for example, 1,000 to 25,000 mm/sec²), the maximum value of injection pressure in a mold inlet is adjusted to a suitable range (for example, 5 to 150 MPa) and the temperature of a mold is adjusted to 80° C., and then injection molding is performed to produce a standard molding. Test pieces including a weld portion are cut out form the obtained standard molding, and then a bending strength test of the weld portion is performed and the strength thereof is measured. Furthermore, surface properties of the molded article are evaluated by, for example, measuring roughness using a surface roughness meter. Then, the temperature of the mold is set to a predetermined temperature of 80° C. or higher and a standard molding is produced in the same manner as described above. The measurement of the strength of the weld portion and evaluation of the surface properties of the molded article are performed, and this operation is repeated at various temperatures. The temperature of the mold is set to a predetermined temperature of 80° C. or lower, and the same operation is repeated. As described above, the temperature of the mold can be optimized from the results of the measurement of the strength of the weld portion and the evaluation of the surface properties of the molded article. While the method of optimizing the temperature of the mold was described herein, the temperature of the liquid crystalline polymer composition, injection acceleration, and the maximum value of the injection pressure in a mold inlet at the time of injection can be easily optimized in the same manner as described above. The bending strength of the weld portion is preferably 15 MPa or more, more preferably 20 MPa or more, and still more preferably 25 MPa or more.

After determining the practical injection molding conditions by the above-mentioned method, molding may be performed after replacing the mold by a mold for obtaining the objective molding.

While the method using a standard molding was described herein, if the measurement of the strength of the weld portion and the evaluation of the surface properties of the molding can be performed in the objective molding, practical injection molding conditions may be determined using this molding.

The molded article of the present invention is suitable for various products or components which are required to have high heat resistance, high strength and high rigidity, for example, bobbins such as an optical pickup bobbin and a trans bobbin; relay components such as a relay case, a relay base, a relay sprue and a relay armature; reflectors such as a lamp reflector and an LED reflector; holders such as a heater holder; diaphragms such as a speaker diaphragm; separation claws such as a separation claw for copying machine, and a separation claw for printer; module components of cameras including a compact camera; switch components; motor components; sensor components; hard disk drive components; tablewares such as an oven ware; vehicle components; aircraft components; and sealing members such as a sealing member for semiconductor device, and a sealing member for coil.

The molded article of the present invention has sufficient strength even if the thickness of the weld portion in the opening portion is 2.5 mm or less, and also suppresses cracking of the weld portion even in the subsequent processes of the cooling process after molding. Also, definite roughening and flow mark do not occur on a surface, and thus surface properties are satisfactory.

### EXAMPLES

The present invention will be described in more detail by way of specific examples. However, the present invention is not limited to the following examples. The flow initiation temperatures of a liquid crystalline polyester and the flow initiation temperatures of a liquid crystalline polyester composition were measured by the following methods.

### (Measurement of Flow Initiation Temperatures of Liquid Crystalline Polyester and Flow Initiation Temperatures of Liquid Crystalline Polyester Composition)

Using a flow tester (Model CFT-500, manufactured by Shimadzu Corporation), about 2 g of a liquid crystalline polyester or liquid crystalline polyester composition was filled in a cylinder with a die including a nozzle having an inner diameter 1 mm and a length of 10 mm attached thereto, and the liquid crystalline polyester or liquid crystalline polyester composition was melted while raising a temperature at a rate of 4° C./minute under a load of 9.8 MPa (100 kg/cm²) and extruded through the nozzle, and then the temperature at which the extrudate showed a viscosity of 4,800 Pa·s (48,000 poise) was measured.

### Production of Liquid Crystalline Polyester

### Production Example 1

In a reactor equipped with a stirrer, a torque meter, a nitrogen gas introducing tube, a thermometer and a reflux condenser, 994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl, 1347.6 g (13.2 mol) of acetic anhydride and 0.194 g of 1-methylimidazole were charged. While stirring under a nitrogen gas flow, the temperature was raised from room temperature to 145° C. over 30 minutes and then the mixture was refluxed at 145° C. for 1 hour. Then, the temperature was raised from 145° C. to 320° C. over 2 hours and 50 minutes while distilling off the by-produced acetic acid and unreacted acetic anhydride. After maintaining at 320° C. for 1 hour, contents were taken out form the reactor and then cooled to room temperature. The obtained solid substance was ground by a grinder to obtain a powdered prepolymer. The prepolymer had a flow initiation temperature of 261° C. Then, the prepolymer was subjected to solid phase polymerization by raising the temperature from room temperature to 250° C. over 1 hour under a nitrogen gas atmosphere, raising temperature from 250° C. to 285° C. over 5 hours and maintaining at 285° C. for 3 hours, and then cooling to obtain a powdered liquid crystalline polyester (LCP1). The liquid crystalline polyester had a flow initiation temperature of 327° C.

### Production of Liquid Crystalline Polyester Composition

### Production Example 2

The liquid Crystalline polyester (LCP1) obtained in Production Example 1 was mixed with the below-mentioned fillers in accordance with the composition shown in Table 1, and then the mixture was granulated at a cylinder temperature of 340° C., using a twin screw extruder (PCM-30, manufactured by Ikegai Iron Works, Ltd.) to obtain pellets of a liquid crystalline polyester composition. The measurement results of the flow initiation temperature (FT: flow temperature) of the obtained pellets are shown in Table 1.

### (Filler)

Glass beads (GB): EGB731-PN (size publicized by manufacturer: center particle diameter of 20 μm), manufactured by Potters-Ballotini Co., Ltd.

Milled glass fiber (mGF): milled fiber glass powder EFH75-01 (size publicized by manufacturer: fiber diameter of 10 μmφ and fiber length of 75 μm), manufactured by Central Glass Co., Ltd.

Chopped glass fiber (cGF): glass chopped strand CS03 JA PX-1 (size publicized by manufacturer: fiber diameter of 10 μmφ and fiber length of 3 mm), manufactured by Owens Corning Corporation

Talc: talc X-50 (plate-shaped filler, center particle diameter of 14.5 μm), manufactured by NIPPON TALC Co., Ltd.

Whisker: aluminum borate whisker ALBOREX G, manufactured by SHIKOKU CHEMICALS CORPORATION.

The center particle diameter means a median diameter D50, and means a numerical value in which when the particle diameter is bipolarized, the amount of particles with a large particle diameter becomes the same as that of particles with a small particle diameter.

### Production of Liquid Crystalline Polyester Molding

### Examples 1 to 5 and Comparative Examples 1 to 4

After drying the pellets of the liquid Crystalline polyester compositions obtained above were dried at 120° C. for 3 hours, liquid crystalline polyester moldings (test piece for evaluation of weld portion) shown in FIG. 1 were produced using an injection molding machine, Model UH-1,000, manufactured by Nissei Resin Industry Co. Ltd., under the conditions shown in Table 1. The size of each molded article in FIG. 1 was as follows: X═Y=64 mm, Z=T₁=0.5 mm, and a diameter of an opening portion is 3 mm. Any molded article satisfied the conditions of L₁≧3T₁. At this time, the maximum value of an injection rate, an attack time and shock pressure (maximum value of injection pressure in a mold inlet) were measured by a waveform monitor to determine injection acceleration. With respect to the obtained molding, the surface properties thereof were evaluated, and then the presence or absence of cracking of the weld portion was confirmed by the following procedures. The results are shown in Table 2.

### (Evaluation of Surface Properties of Liquid Crystalline Polyester Molded Article)

The presence or absence of roughening and a flow mark were evaluated by visually observing a surface of a molded article.

### (Confirmation of Presence or Absence of Cracking of Weld Portion)

On the 14th day after injection molding, a weld portion of a molded article was observed at a magnification of 20 times using a microscope.

### Example 6

In the same manner as in Example 1, except that an injection molding machine, Model PS40E5ASE, manufactured by Nissei Resin Industry Co. Ltd., was used, a molding was produced, and then the maximum value of an injection rate, an attack time and shock pressure were measured to determine injection acceleration. The surface properties of the obtained molded article were evaluated, and the presence or absence of cracking of a weld portion was confirmed. The results are shown in Table 2. MOBAC M220-16 manufactured by Nireco Corporation was used as a waveform monitor. In this injection molding machine, setting of the injection rate cannot be expressed by “mm/sec (millimeters/seconds)” unit. Therefore, the injection rate was expressed by % in Table 1 (see “*”).

TABLE 1

| | Liquid crystalline polymer | | | | | | | |
|---|---|---|---|---|---|---|---|---|
| | composition | | | | | | | |
| | Liquid | | | Maximum | | | | |
| | crystalline | | Flow | value of | | | | |
| | polymer | Filler | initiation | injection | Injection | Shock | Molding | Mold |
| | (% by | (% by | temperature | rate | acceleration | pressure | temperature | temperature |
| | mass) | mass) | (° C.) | (mm/sec) | (mm/sec²) | (MPa) | (° C.) | (° C.) |
| Example 1 | LCP1 | GB | 323 | 200 | 11062 | 132 | 360 | 80 |
| | (60) | (40) | | | | | | |
| Example 2 | LCP1 | GB/cGF | 325 | 200 | 11058 | 146 | 360 | 80 |
| | (60) | (30/10) | | | | | | |
| Example 3 | LCP1 | GB | 323 | 200 | 11032 | 162 | 320 | 80 |
| | (60) | (40) | | | | | | |
| Example 4 | LCP1 | GB | 323 | 200 | 11045 | 128 | 360 | 20 |
| | (60) | (40) | | | | | | |
| Example 5 | LCP1 | GB | 323 | 50 | 1680 | 87 | 360 | 80 |
| | (60) | (40) | | | | | | |
| Example 6 | LCP1 | GB | 323 | 99.9%* | 780 | 150 | 360 | 80 |
| | (60) | (40) | | | | | | |
| Comparative | LCP1 | cGF | 324 | 200 | 11027 | 185 | 360 | 80 |
| Example 1 | (60) | (40) | | | | | | |
| Comparative | LCP1 | mGF | 323 | 200 | 11065 | 125 | 360 | 80 |
| Example 2 | (60) | (40) | | | | | | |
| Comparative | LCP1 | Talc | 321 | 200 | 11083 | 110 | 360 | 80 |
| Example 3 | (60) | (40) | | | | | | |
| Comparative | LCP1 | Whisker | 321 | 200 | 11083 | 110 | 360 | 80 |
| Example 4 | (60) | (40) | | | | | | |

TABLE 2

| | | Cracking of |
|---|---|---|
| | Surface properties | weld portion |
| Example 1 | ◯ | Not observed |
| Example 2 | ◯ | Not observed |
| Example 3 | Δ | Not observed |
| | (Slight roughness is observed) | |
| Example 4 | Δ | Not observed |
| | (Slight roughness is observed) | |
| Example 5 | ◯ | Not observed |
| Example 6 | ◯ | Not observed |
| Comparative | X | Not observed |
| Example 1 | (Clear flow mark and roughening | |
| | are observed) | |
| Comparative | Δ | Observed |
| Example 2 | (Slight roughness is observed) | |
| Comparative | ◯ | Observed |
| Example 3 | | |
| Comparative | X | Not observed |
| Example 4 | (Clear flow mark is observed on | |
| | surface) | |

As is apparent from the above results, the molded articles of Examples 1 to 6 caused neither cracking of the weld portion nor cracking in the cooling process after molding, and also had sufficient strength. Slight roughening was partially observed on surfaces of the molded article. However, there was no hindrance in practical use, and also no flow mark was observed and surface properties were satisfactory. To the contrary, in the molded articles of Comparative Examples 1 to 4, either cracking of the weld portion or deterioration of surface properties was definitely confirmed.

The present invention can be used in electric and electronic components each including a thin wall portion, and electric and electronic components each including high output and high capacity which are exposed to a high temperature when used, automotive members and the like.

What is claimed is:

1. A liquid crystalline polymer molded article comprising an opening portion obtained by subjecting a liquid crystalline polymer composition containing a spherical filler to injection molding, wherein
the liquid crystalline polymer molded article includes a weld portion, formed by injection molding, which extends toward the outside from the opening portion, and
the weld portion has a thickness in the opening portion of 2.5 mm or less, and also has a length, along a surface of the molding, of at least two times the thickness.

2. The liquid crystalline polymer molded article according to claim 1, wherein the liquid crystalline polymer is a liquid crystalline polyester.

3. The liquid crystalline polymer molded article according to claim 2, wherein the liquid crystalline polyester includes a repeating unit derived from p-hydroxybenzoic acid in the proportion of 30 mol % or more based on the total amount of the whole repeating unit which constitutes the liquid crystalline polyester.

4. The liquid crystalline polymer molded article according to claim 1, which is obtained by injection molding under the conditions that injection acceleration defined by dividing the maximum value of an injection rate by time required to reach the maximum value from initiation of the injection is from 1,000 to 25,000 mm/sec², and also the maximum value of injection pressure in a mold inlet is from 5 to 150 MPa in one injection molding.

5. The liquid crystalline polymer molded article according to claim 1, which is obtained by injection molding under the conditions that the temperature of the liquid crystalline polymer composition at the time of injection is [flow initiation temperature of the liquid crystalline polymer composition+20° C.] or higher and [flow temperature of the liquid crystalline polymer composition+80° C.] or lower.

6. The liquid crystalline polymer molded article according to claim 1, which is obtained by injection molding under the conditions that the temperature of a mold at the time of injection molding is 80° C. or higher and [flow initiation temperature of the liquid crystalline polymer composition−100° C.] or lower.

7. The liquid crystalline polymer molded article according to claim 1, which is a component for a compact camera module.
